(19) United States
(12) Patent Application Publication
(10) Pub. No.: US 2004/0181382 A1
(43) Pub. Date: Sep. 16, 2004

(54) Visualizing the surface of a liquid

(76) Inventors: Yaohua Hu, Beijing (CN); Xin Tong, Beijing (CN); Baining Guo, Bellevue, WA (US)

Correspondence Address: LEE & HAYES PLLC, 421 W RIVERSIDE AVENUE SUITE 500, SPOKANE, WA, 99201

(21) Appl. No.: 10/389,122

(22) Filed: Mar. 14, 2003

(51) Int. Cl. G06G 7/48; G06G 7/50

(52) U.S. Cl. 703/9

(57) ABSTRACT

Visualizing the surface of a liquid in real-time may be enabled using (i) a view-dependent representation of wave geometry and/or (ii) a Fresnel bump mapping for representing Fresnel reflection and refraction effects. In a described implementation, the liquid comprises an ocean that is simulated and rendered. In a first exemplary media implementation, electronically-executable instructions thereof direct an electronic device to execute operations that include: simulate a near patch of a surface of a liquid that is proximate to a viewpoint, the near patch including a representation of liquid waves in three dimensions; and simulate a far patch of the surface of the liquid that is distant from the viewpoint. In a second exemplary media implementation, instructions thereof direct actions that include: simulating a surface of a liquid to determine dimensional wave features; and rendering the surface of the liquid by applying a Fresnel texture map to the dimensional wave features.

### TECHNICAL FIELD

This disclosure relates in general to visualizing the surface of a liquid in real-time and in particular, by way of example but not limitation, to using an electronic device to simulate and render the surface of the ocean with (i) a view-dependent representation of wave geometry and/or (ii) a Fresnel bump mapping for representing Fresnel reflection and refraction effects.

### BACKGROUND

Visualization of ocean surfaces is a very important topic in computer graphics because the ocean is present in many natural scenes. Realistic ocean rendering therefore enhances the immersive experience and/or the accuracy of an interactive simulation of natural scenes. Such natural scenes or other environments may be simulated for gaming, virtual reality, or other purposes.

Realistic ocean simulation with rendering has been successfully used in the film industry. However, these techniques are only appropriate for off-line rendering of animated sequences, and they cannot be used in real-time applications. An example of such an off-line technique is presented by Tessendorf, J. in an article entitled “Simulating Ocean Waters” in SIGGRAPH course notes, ACM SIGGRAPH 2001.

In Tessendorf, several principles for realistic simulation of ocean waves are presented. These principles include: a spectral method for modeling wave geometry and also a complex lighting model of the ocean water. Such techniques are now widely used in the film industry. Although the spectral method is conceptually simple, it still cannot be used to generate the ocean waves in real time with today's hardware limitations. Furthermore, the complex lighting model by itself is too complicated to be used for real time rendering.

In existing games and other real-time applications, the ocean surface is typically modeled as a texture-mapped plane with simple lighting effects. Consequently, realistic wave geometry and sophisticated lighting effects such as Fresnel effects are ignored.

In short, previous approaches either generate a very realistic rendering of ocean scenes as an off-line process or produce an inferior rendering of the ocean in real-time without realistic lighting. Accordingly, there is a need for practical schemes and/or techniques for realistic real-time ocean visualization.

### SUMMARY

Visualizing the surface of a liquid in real-time may be enabled using (i) a view-dependent representation of wave geometry and/or (ii) a Fresnel bump mapping for representing Fresnel reflection and refraction effects. In a described implementation, the liquid comprises an ocean that is simulated and rendered.

In a first exemplary media implementation, electronically-executable instructions thereof direct an electronic device to execute operations that include: simulate a near patch of a surface of a liquid that is proximate to a viewpoint, the near patch including a representation of liquid waves in three dimensions; and simulate a far patch of the surface of the liquid that is distant from the viewpoint.

In a second exemplary media implementation, electronically-executable instructions thereof direct an electronic device to perform actions that include: simulating a surface of a liquid to determine dimensional wave features; and rendering the surface of the liquid by applying a Fresnel texture map to the dimensional wave features.

In an exemplary system implementation, a system for rendering a surface of a liquid comprises: at least one pixel shader, the at least one pixel shader including: a loading mechanism that is adapted to load a bump texture that represents a small-scale simulation of the surface of the liquid and to load at least a portion of a Fresnel map; a bumping mechanism that is capable of bumping texture coordinates using the bump texture, the bumping mechanism adapted to: bump reflection texture coordinates and compute a reflection color component, bump refraction texture coordinates and compute a refraction color component, and bump Fresnel texture coordinates from the at least a portion of the Fresnel map and ascertain a Fresnel value; and a combining mechanism that is adapted to combine the reflection color component and the refraction color component responsive to the Fresnel value.

Other method, system, apparatus, media, arrangement, etc. implementations are described herein.

### BRIEF DESCRIPTION OF THE DRAWINGS

The same numbers are used throughout the drawings to reference like and/or corresponding aspects, features, and components.

FIG. 1 illustrates an exemplary general approach to visualizing the surface of the ocean.

FIG. 2 is a graph that illustrates an exemplary view-dependent approach to representing wave geometry using a near patch and a far patch.

FIG. 3 is a graph that illustrates an exemplary approach to constructing the far patch of FIG. 2.

FIG. 4 is a graph that illustrates an exemplary model of the geometry of light transport at the surface of the ocean.

FIG. 5 is a graph that illustrates an exemplary model of the geometry of a refraction color computation at the surface of the ocean.

FIG. 6A is a graph that illustrates an exemplary coordinate frame that is usable for Fresnel texture construction.

FIG. 6B is a graph that illustrates an exemplary Fresnel texture resulting from a Fresnel texture construction in accordance with the coordinate frame of FIG. 6A.

FIG. 7 illustrates a first exemplary graph that includes a bumped normal and a second exemplary graph that includes a bumped view vector.

FIG. 8 is a graph that illustrates an exemplary bumped reflection map for a one dimensional (1D) case.

FIGS. 9A and 9B are graphs that illustrate an exemplary refraction map generation for a 1D case.

FIG. 10 includes a vertex shader and a pixel shader that illustrate an exemplary approach for visualizing the surface of a liquid from a pipelined perspective.

FIG. 11 illustrates an exemplary computing (or general electronic device) operating environment that is capable of (wholly or partially) implementing at least one aspect of visualizing the surface of a liquid as described herein.

### DETAILED DESCRIPTION

Generally, the surface of a liquid may be visualized in real-time for various interactive applications such as visual simulators and games. One or more electronic devices may be used to visualize the surface of the liquid. In this context, visualization includes simulation and rendering of the liquid surface, and optionally includes realizing an image of the liquid surface on a display screen. Although the implementations described herein may be applied to liquids in general, a described implementation focuses on realistic wave geometry and sophisticated lighting for simulating and rendering the surface of the ocean or other large bodies of water.

Simulating and rendering the surface of the ocean is accomplished using (i) a view-dependent representation of wave geometry and/or (ii) a Fresnel bump mapping for representing Fresnel reflection and refraction effects. More specifically, the view-dependent representation of wave geometry is capable of realistically describing the geometry of the nearby waves while efficiently handling the far away waves by dividing the simulated ocean surface into a near patch and a far patch, respectively. The Fresnel bump mapping is derived from a Fresnel texture map and a bump map. The Fresnel bump mapping enables techniques for efficiently rendering per-pixel Fresnel reflection and refraction on a dynamic bump map. The inclusion of these Fresnel effects when visualizing the ocean surface is helpful for reproducing the “texture” and/or “feel” of the water.

The simulating and rendering may be fully or partly accomplished using graphics-oriented hardware. For example, vertex shaders and pixel shaders of a personal computer (PC) graphics board or a game console are capable of implementing the described techniques. Graphics cards and game consoles typically have a programmable graphics processing unit (GPU) that may be employed to implement the view-dependent representation of wave geometry and/or the Fresnel bump mapping for representing Fresnel reflection and refraction effects. Using at least one of these two ocean surface representation approaches enables real-time rendering, at sixty frames per second (60 fps) for example. An exemplary electronic device/computing environment that may be used to realize the implementations described herein is described further below with reference to FIG. 11.

Exemplary General Approach to Visualizing the Surface of the Ocean

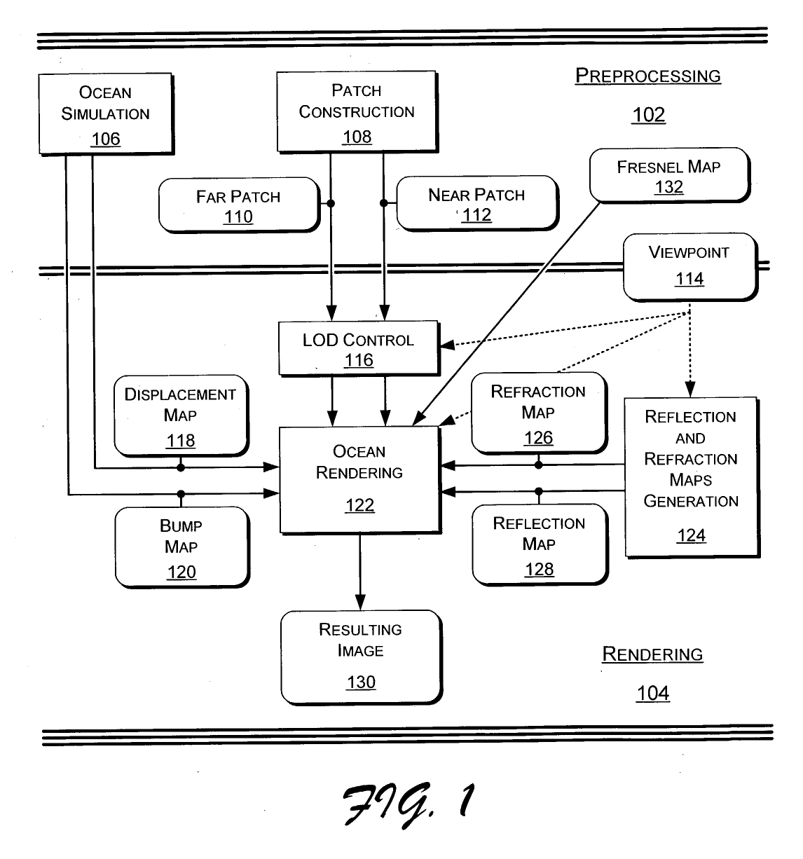

FIG. 1 illustrates an exemplary general approach to visualizing the surface of the ocean. In a described implementation, the approach is divided into two stages: a preprocessing stage 102 and a rendering stage 104. In preprocessing stage 102, an ocean simulation operation 106 and a patch construction operation 108 are performed. In rendering stage 104, a level of detail (LOD) control operation 116, a reflection map and refraction map generation operation 124, and an ocean rendering operation 122 are performed. These operations may also be considered blocks, units, mechanisms, etc. for implementations that are realized in hardware, software, firmware, some combination thereof, and so forth.

The current viewpoint 114 is input to LOD control operation 116, reflection and refraction map generation operation 124, and ocean rendering operation 122. As described further below, two patches (110 and 112) and one map (132) that are shown in preprocessing stage 102 and four maps (118, 120, 126, and 128) that are shown in rendering stage 104 are intermediate products used to visualize a resulting image 130.

In preprocessing stage 102, ocean wave simulation 106 generates a displacement map 118 and a bump map 120. Displacement maps 118 are used to model the geometry of waves, whereas bump maps 120 are applied during rendering stage 104 to enhance the details of wave surfaces. A bump map 120 is also applied to a pre-computed Fresnel texture map 132 to derive the Fresnel bump mapping effect. Also in preprocessing stage 102, a view-dependent representation of ocean wave geometry is constructed at patch construction 108. This representation includes a near patch 112 and a far patch 110.

Near patch 112 and far patch 110 are input to LOD control 116 as part of rendering stage 104. LOD control 116 enables optional control over the minimum and maximum level of detail in the mesh. For example, techniques that are used for terrain LOD control can be modified for application to LOD control of liquid patches. LOD control operation 116 passes near patch 112 and far patch 110, as optionally modified thereby, to ocean rendering operation 122.

Also in rendering stage 104, a reflection map 128 and a refraction map 126 for each view are generated at reflection and refraction map generation operation 124. At ocean rendering operation 122, the view-dependent wave geometry of near and far patches 112 and 110 in conjunction with displacement and bump 19 maps 118 and 120, along with the reflection, refraction, Fresnel, and sunlight effects, are combined to produce resulting image 130.

Ocean Simulation 106 and Patch Construction 108

A spectral scheme is used to generate ocean wave shapes and dynamics. This spectral scheme is a statistical model that is based on experimental observations from the oceanographic literature. A similar spectral scheme is also used by Tessendorf, J. in the article entitled “Simulating Ocean Waters” in SIGGRAPH course notes, ACM SIGGRAPH 2001. “Simulating Ocean Waters” by J. Tessendorf is hereby incorporated by reference in its entirety herein.

The spectral scheme used in an implementation described herein entails determining wave geometry with an equation based on the statistical model. Specifically, the following formula is used to generate a height field that represents the ocean waves over a rectangular region:

$$h ( p , t ) = {\sum }_{k} \tilde{h} ( k , t ) exp ( ik \cdot p ) ,$$

where “t” is the time and “k” is a two-dimensional vector with components k=(kₓ, k_{z}), in which kₓ=2πn/Lₓ, k_{z}=2πm/L_{z}, and n and m are integers with bounds −N/2≦n≦N/2 and −M/2≦m≦M/2, with “L” being a length parameter.

This ocean simulation result, which is over a rectangle region in an X-Z plane that corresponds to the ocean surface, is a time-variant height field defined at discrete points p=(nLₓ/N, mL_{z}/M). This height field may be sampled at different spatial resolutions to get differing representations of ocean waves at different scales. For example, by setting N=7 and M=7, a 7×7 displacement map 118 results for the large-scale geometry of ocean waves that may be tiled for the ocean surface. Also, by setting N=128 and M=128, a 128×128 bump map 120 results for describing the fine details on wave surfaces. For both displacement and bump maps 118 and 120, 17 samples are taken in one wave period, and these 17 samples are played periodically to simulate the wave dynamics during rendering time. It should be noted that other simulation scaling numbers and alternative sampling rates may be employed instead. Additionally, any technique that generates a tileable height field for the ocean surface may alternatively be used.

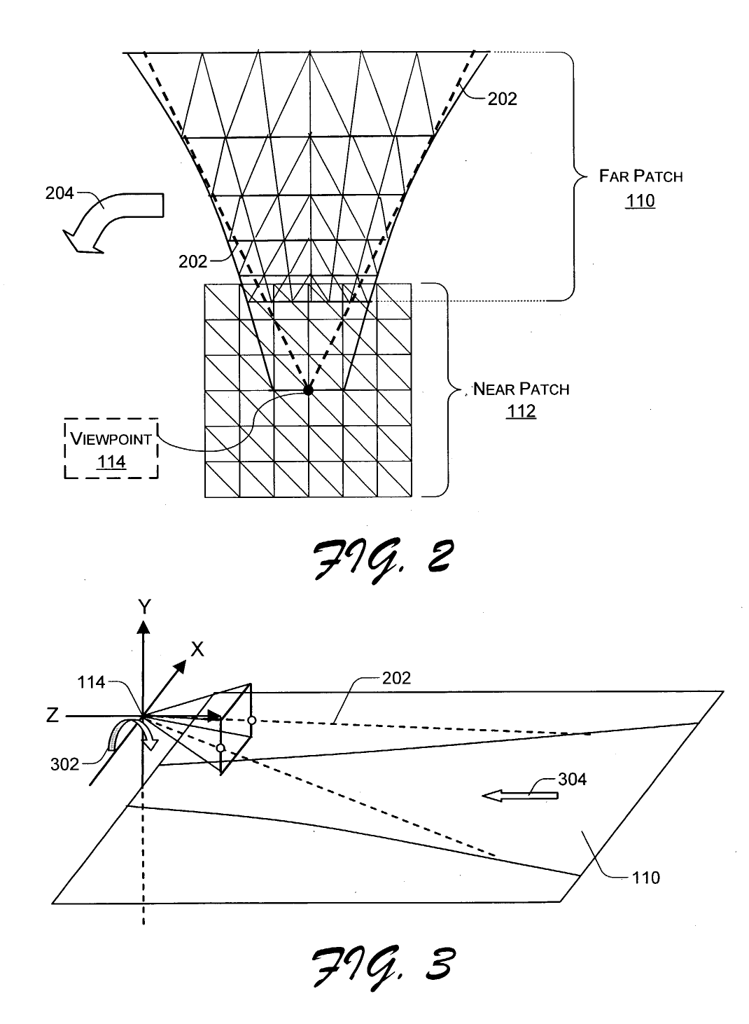

Using patch construction 108, the ocean surface is divided into near patch 112 and far patch 110. In a described implementation, near patch 112 is an at least approximately rectangular region of the ocean surface that is centered on viewpoint 114. Near patch 112 reflects the calculated large-scale wave geometry to fully reflect the varying heights of ocean waves and is thus based on a three-dimensional (3D) model. Far patch 110, on the other hand, is located distal from viewpoint 114 along the viewing frustum and is based on a planar model. Construction and manipulation of near patch 112 and far patch 110 is described further below with reference to FIGS. 2 and 3.

Reflection and Refraction Maps Generation 124

Refraction map 126 is generated by rendering the objects that are under the plane of the water surface to a texture. In the open ocean, light is both scattered and absorbed by a given depth and/or volume of water. This overall water attenuation effect is approximated by fog-from depth effects during generation of refraction map 126.

In order to generate reflection map 128, each object above the ocean is first transformed to its symmetric position under the plane of the water surface. These objects are then rendered from viewpoint 114, and the result is saved into reflection texture map 128. Both reflection and refraction maps 128 and 126 are used as projective texture maps during rendering.

Ocean Rendering 122

After obtaining reflection and refraction maps 128 and 126, the view-dependent wave geometry (e.g., near and far patches 112 and 110) may be rendered by the graphics hardware via vertex and pixel shaders. In a described implementation, the final pixel color (e.g., a pixel color that is ready for display) may be computed by the following equation:

C_{water}=F*C_{refract}+(1−F)*C_{reflect}+C_{sunlight},

where “C_{water}” refers to the visualized water color of the ocean surface, “F” refers to the Fresnel effect, “C_{refract}” refers to both refractive effects and the color of objects (including the ocean floor) under the ocean surface, “C_{reflect}” refers to the color of objects (including possibly the sky) above the ocean surface that reflect off of the ocean surface, and “C_{sunlight}” refers to the color of sunlight that is reflected off of the ocean surface.

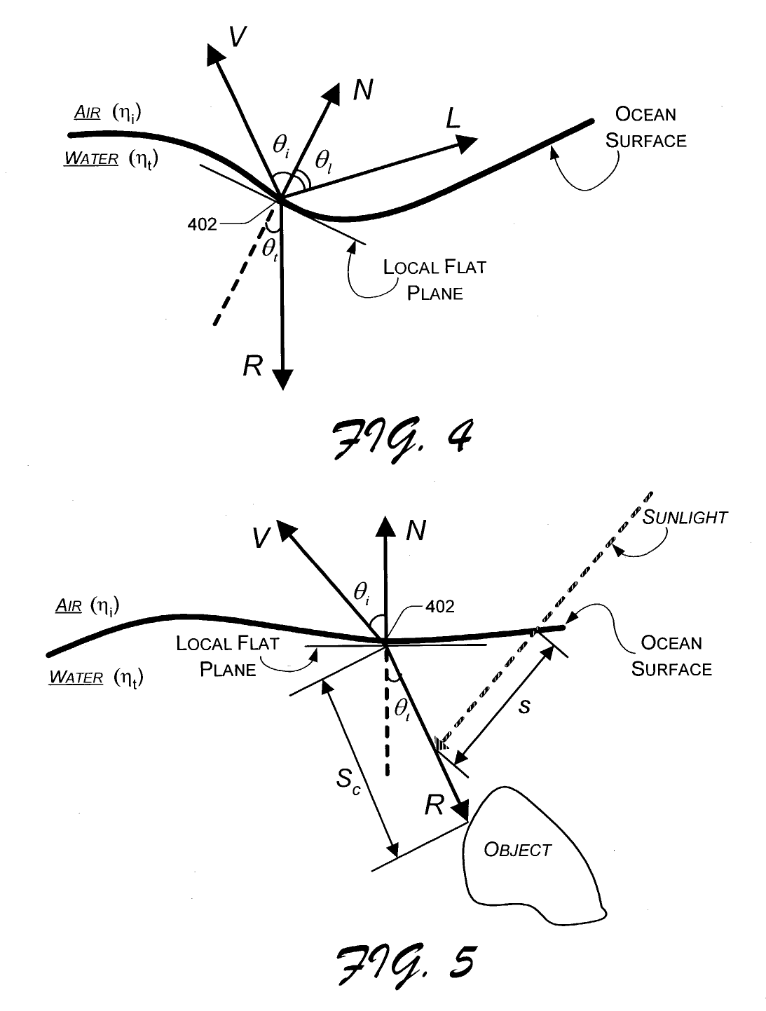

The variation of the reflectivity and refractivity across. (e.g., the Fresnel effect of) the ocean surface is an important feature of ocean water appearance. To render the water surface with realistic details, the Fresnel term F is pre-computed and stored into a channel (e.g., the alpha channel) of a Fresnel texture map. A normalized version of the current view vector may be stored in another channel (e.g., the color channel) of the Fresnel texture map. Creating and using a Fresnel texture map is described further below, especially with reference to FIGS. 4-6B.

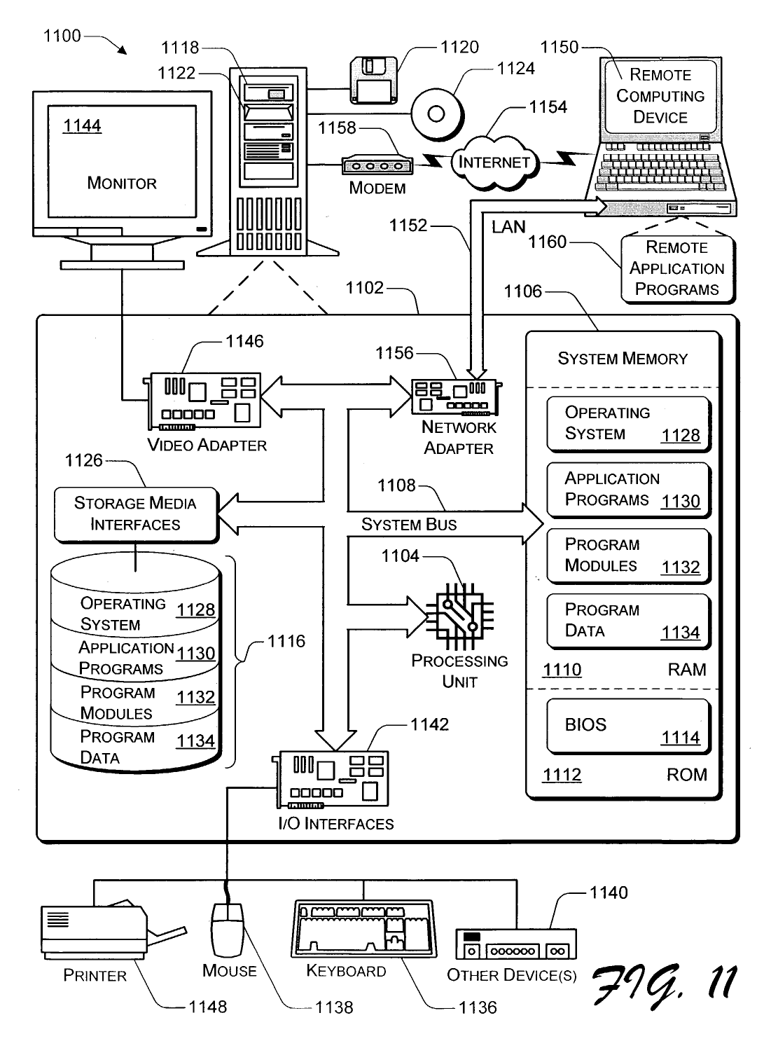

At least much of the ocean rendering for operation 122 may be accomplished using a vertex shader and a pixel shader. Ocean rendering 122 with a vertex shader and a pixel shader from a pipelining perspective is described further below with reference to FIG. 10. However, a general description follows. Generally, the near and far patch 112 and 110 mesh vertices' 2D position, which are coordinates on a plane that corresponds to the ocean surface, are input into the vertex shader. To compute the lighting effects, viewpoint position 114 and the sunlight (or other light) direction is also input. In the vertex shader for near patch 112, the mesh thereof is transformed into the world space, and its vertice' heights are then found by looking them up using displacement map 118.

The 2D position of each vertex on the ocean plane is used as the texture coordinates for bump map 120, reflection map 128, and refraction map 126. After computing the view vector for each vertex, the sunlight reflection color of each vertex is also computed in the vertex shader. The x- and z-components of the normalized view vector are used as the texture coordinates for the Fresnel texture. Finally, the texture coordinates, the per-vertex sunlight reflection color, and the light direction are output to the pixel shader.

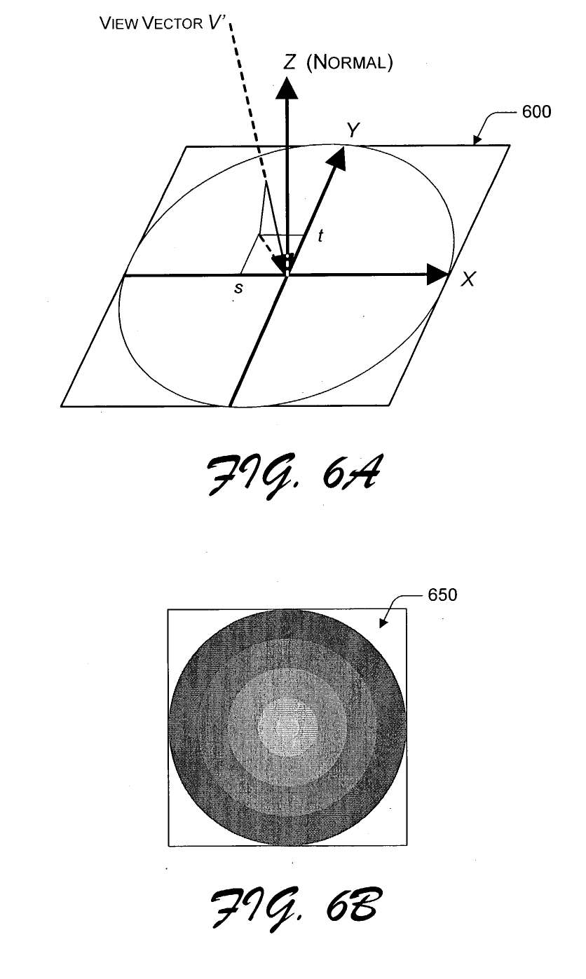

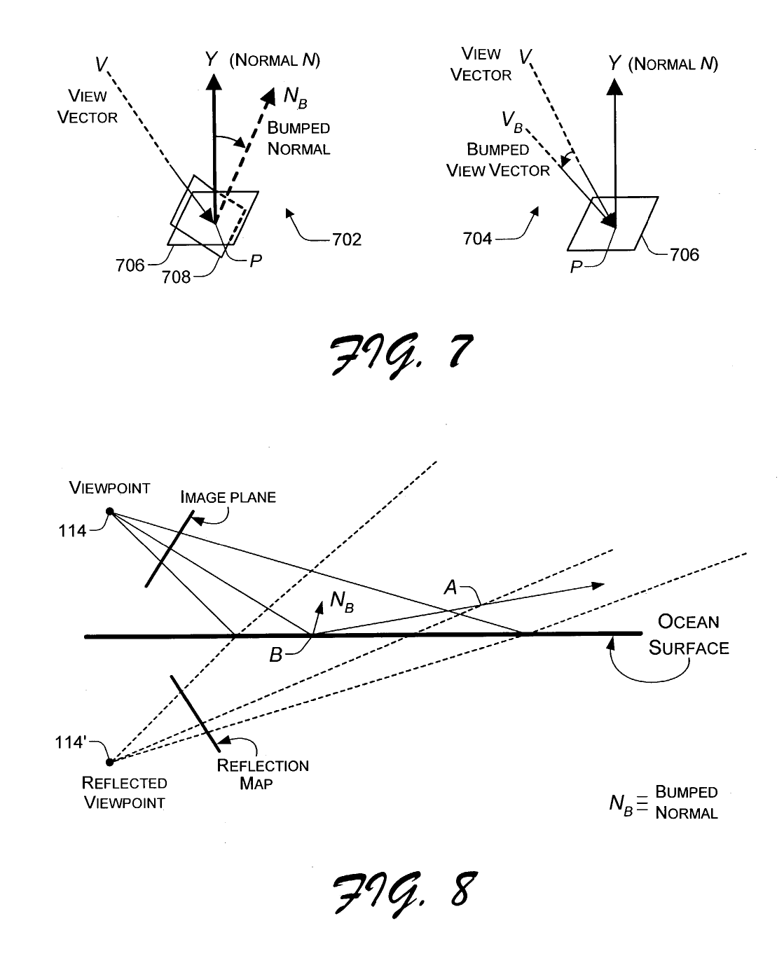

In the pixel shader for each pixel, bump map 120 is used to perturb Fresnel, reflection, and refraction texture coordinates. As described further below, especially with reference to FIGS. 6A-9B, the perturbed texture coordinates are then used to find the Fresnel term F, the reflection color C_{reflect} and the refraction color C_{refract} in the Fresnel texture map, reflection map 128, and refraction map 126, respectively. The sunlight reflection color C_{sunhight} for each pixel is also computed and then multiplied with the interpolated per-vertex sunlight reflection color. The final color C_{water} of each pixel is determined by combining the four components together.

Exemplary Approach to View-Dependent Wave Geometry.

The height field that is computed on a rectangular region using the equation from the statistically-modeled spectral scheme can be tiled seamlessly to cover an arbitrarily large ocean plane. Unfortunately, this is insufficiently efficient for real-time ocean visualization. However, the view-dependent representation of wave geometry increases the efficiency of describing oceanic waves in the viewing frustum.

FIG. 2 is a graph that illustrates an exemplary view-dependent approach to representing wave geometry using near (surface) patch 112 and far (surface) patch 110. Viewpoint 114 is indicated as a black dot and located at the approximate center of near patch 112. The current viewing frustum 202 is indicated by the thick dashed lines emanating from viewpoint 114. As illustrated, near patch 112 and far patch 110 together cover an ocean surface region that is a slightly larger than the ocean surface region in the current viewing frustum 202.

With regard to near patch 112, the geometric details of the ocean waves that are near to viewpoint 114 are represented. Thus, in a described implementation, near patch 112 is a flat, fix-sized patch that is used to describe or represent the height field around viewpoint 114. The size of near patch 112 is set large enough to cover all ocean waves having visible height variations for all viewing heights and viewing directions.

The height field of near patch 112 is sampled from the tiled 7×7 displacement map 118. The position of near patch 112 is forced into alignment with the 7×7 height field grid to ensure that the height field remains consistent as viewpoint 114 moves. For the same reason, the mesh of near patch 112 moves by one grid point each time that viewpoint 114 moves (e.g., when it moves laterally or backwards/forwards within the X-Z plane). The mesh resolution of near patch 112 changes with the height of viewpoint 114, but it remains the same when only the viewing direction changes or when viewpoint 114 only moves laterally or backwards/forwards.

FIG. 3 is a graph that illustrates an exemplary approach to constructing far patch 110. Viewpoint 114 is located at the origin of an x-axis/y-axis/z-axis coordinate system. The view extends in a positive direction with the z-axis along viewing frustum 202 towards far patch 110.

Far patch 110 is used to fill the visible ocean surface from the distal or far-end of near patch 112 to the horizon (as shown in FIG. 2). Far patch 110 is planar with no height field, and ocean waves are represented by bump map 120 on the plane of the ocean surface. To avoid generating a new far patch 110 for each frame, far patch 110 is constructed in preprocessing stage 102.

As illustrated in FIG. 3, for a viewpoint 114 that is located at the origin with the viewing direction rotating around the x-axis, the visible area on the ocean plane (at height -h) is bounded by two curves defined by far patch 110. Far patch 110 is tessellated based on the viewing distance. Thus, far patch 110 can be used for all views that are obtained by or result from rotating the viewing direction around the x-axis (e.g., when looking up and down), as indicated by arrow 302.

When viewpoint 114 moves along the y-axis (e.g., when the altitude of viewpoint 114 changes), far patch 110 is scaled to cover the new visible area on the ocean surface, as indicated by arrow 304. If the viewing direction rotates around the y-axis (e.g., when looking left and right), far patch 110 is rotated to the corresponding visible area, as indicated by arrow 204 (in FIG. 2). Thus, the pre-computed far patch 110 can be used for any view above the ocean surface.

To stitch far patch 110 and near patch 112 together seamlessly, the height or altitude (e.g., the y-value) of the vertices on near patch's 112 boundary are forced to zero (0). To avoid overlapping and complex blending between the two patches 110 and 112, the triangles of far patch 110 are processed during rendering according to the following two steps: First, the triangles of far patch 110 that are totally within the region of near patch 112 are culled. Second, for triangles of far patch 110 that are only partly within near patch 112, the inside vertices thereof are moved to the near patch 112 boundary so that the far patch triangles are seamlessly connected tonear patch 112.

Exemplary Approach to Rendering Ocean Waves

An exemplary implementation of a physical lighting model of the ocean waves is described. In this model, it is assumed that the ocean surface is a “nearly perfect specular reflector.” In other words, the ocean surface is treated as a set of locally planar facets.

FIG. 4 is a graph that illustrates an exemplary model of the geometry of light transport at the surface of the ocean. A “local flat plane” is shown against the “ocean surface” at a point 402. Extending from point 402 are a lighting/reflection ray/direction “L”, a view vector “V”, a surface normal “A,”, and a refraction ray/direction “R”. An angle “θᵢ” is defined by view vector V and surface normal N, and an angle “θₗ” is defined by lighting/reflection ray L and surface normal N. Another angle “θₜ” is defined by refraction ray R and the underwater extension of surface normal N.

Because each facet is regarded as a perfect or nearly perfect mirror, for any view vector V, only the incident rays coming from reflection direction L and refraction direction R need be considered. View vector V and reflection ray L have the same angle with respect to the surface normal N; therefore, angle θᵢ equals angle θₗ Refraction ray R and thus angle θₜ follow Snell's rule for refraction. Consequently, the radiance along view direction V can be determined by:

C_{water}=F·C_{reflect}+(1−F)*C_{refract},

where the variable “F” is the Fresnel term. This Fresnel term “F” may be computed as described below.

Fresnel Term “F”

In a described implementation, the Fresnel term F is computed using the following equation:

$${F}_{λ} = \frac{1}{2} \frac{{( g - c )}^{2}}{{( g + c )}^{2}} ( 1 + \frac{{[ c ( g + c ) - 1 ]}^{2}}{{[ c ( g - c ) + 1 ]}^{2}} ) ,$$

where c=cosθᵢ=L·H, g²=η_{λ}²+c²−1 and η_{λ}=η_{tλ}/η_{iλ}.

Here ηtλ and η_{iλ} are indices of refraction of the two media (water and air). Vector “H” is the, normalized half vector of lighting vector L and view vector V. For the ocean surface, vector H is the same as the local surface normal N. Thus, because c=L·H=L·N=V·N, the Fresnel term F is a function of V·N.

Because the Fresnel term F is a function of V·N, the Fresnel term F varies quickly on the ocean surface due to normal variation of the detailed waves, which causes the incident angle to change rapidly. Consequently, the color variation that is due to the Fresnel effect across the resulting visualized images is a very important feature of ocean surface appearance.

Reflection

The reflection color C_{reflect} can be directly traced along the reflection direction L=2N−V. However, if a high-dynamic range image cannot be used to represent the irradiance, the reflection Cₑₙᵥᵢᵣ caused by the environment and the reflection C_{specular} caused by light sources (such as sunlight) may be computed separately. Thus, reflection color C_{reflect} may be computed according to the following equation:

C_{reflect}=Cₑₙᵥᵢᵣ+C_{specular}.

Refraction

The refraction color C_{refract} also contains two parts: (i) the object color “C_{bottom}” of the object under the water (possibly the ocean floor) and (ii) the color of the water “C_{depth}_{_{—}}_{water},” which is a function of the depth or volume of water between the object and the ocean surface. Thus, the refraction color C_{refract} may be computed according to the following equation:

C_{refract}=C_{bottom}+C_{depth}_{_{—}}_{water},

FIG. 5 is a graph that illustrates an exemplary model of the geometry of the refraction color “C_{refract}” computation at the surface of the ocean. As compared to FIG. 4, an “object” is shown below the ocean surface in FIG. 5. The distance between the object and the ocean surface along the refracted ray R is designated as “S_{C}”. “Sunlight” is also shown as piercing the ocean surface and extending into the ocean to a length or depth that is designated by “s”.

Given view vector V, the refraction ray direction R can be computed by Snell's rule. Using Snell's rule with the angle and index of refraction designations of FIG. 5, the following equation results:

ηᵢ sin θᵢ=ηₜ sin ηₜ.

The azimuth angle of the refraction vector R is the same as the azimuth angle of the view vector V.

The refracted object color C_{bottom} can be computed as:

C_{bottom}=C_{obj}e^{-KSc},

where “C_{obj}” is the object color and “K” is the diffuse extinction coefficient of water. The variable “S_{c}” is the distance in the ocean from the object to the camera.

The color of the water depth or volume C_{depth}_{_{—}}_{water} can be computed by the following simplified formula:

$${C}_{depth\_water} = {\int }_{{S}_{c}}^{} {Ce}^{- K1} ⅆ l = {C}^{′} {e}^{- Sc} ,$$

where “C” is the color of unit length water. The variable “C′” can be derived from the integration equation, which corresponds to the scaled C.

Exemplary Approach to a Realistic Real-Time Rendering of Ocean Waves

This section describes exemplary implementations that utilize simplifying assumptions and/or efficient computations to enhance the realism and/or efficiency of the real-time rendering of ocean waves.

Ocean Wave Representation

The lighting model for ocean waves as described above indicates that the normal variation of the ocean surface plays a more important role than large-scale ocean surface geometry with respect to ocean surface appearance. For calm ocean waves that are simulated in accordance with a described implementation, the occlusion between the waves is not obvious. Consequently, flat triangles are used with bump maps to model the ocean surface.

Specifically, to model the ocean surface with flat triangles and bump maps, the ocean surface is set to y=h_{water} and bump maps are tiled thereon. For each position (x, y, z), the normal thereof is (0.0, 1.0, 0.0). After bump mapping, the normal therefore becomes (du, \sqrt{1.0−du²−dv²}, dv), in which fix, z)=(du, dv) is the bump value for this position.

Lighting Model Approximation

In a described implementation, in order to expedite ocean rendering and to facilitate ocean rendering in a single pass with slower graphics hardware, the lighting model as described above is simplified. For example, the color of the ocean surface C_{water} can be computed according to the following equation:

C_{water}=F*C_{reflect}+(1−F)*C_{refract}+C_{specular},

where F=F (V·N). The equation for C_{water} therefore becomes:

C_{water}=F(V·N)C_{reflect}+(1−F(V·N))C_{refract}+C_{specular}.

Fresnel on Bumped Ocean Surface

To implement the Fresnel effect, the Fresnel term is pre-computed and stored into a texture map. A straightforward solution is to use a 1D texture map for the Fresnel term F, which is indexed by V·N. However, to apply the Fresnel term F with a bumped ocean surface, the pre-computed Fresnel term is stored into a 2D texture map instead. Using a 2D texture map facilitates combination of it with 2D bump maps for computations for the lighting model.

FIG. 6A is a graph that illustrates an exemplary coordinate frame 600 that is usable for Fresnel texture construction. Coordinate frame 600 includes an x-axis and y-axis forming a plane that may correspond-to a local flat plane on the ocean surface. A z-axis forms a normal with respect to this plane. A normalized view vector V′ is also illustrated that impacts this plane at the origin of the three-axis coordinate system. By assuming that the surface normal points in the positive direction of the z-axis in the local coordinate frame 600, the 2D Fresnel texture stores the Fresnel term for all possible view directions. For each texel (s, t), the Fresnel value is computed for the normalized local view vector V′ (S−0.5t−0.5, {square root over (1−(s−0.5)²−(t−0.5)²))}.

FIG. 6B is a graph that illustrates an exemplary Fresnel texture 650 resulting from a Fresnel texture construction in accordance with coordinate frame 600 of FIG. 6A. Fresnel texture 650 appears as a set of concentric circles. In short, to construct a Fresnel texture, for each normalized view vector V′ of a given coordinate frame, the Fresnel term thereof is pre-computed in local coordinate frame 600 and the resulting values are stored into Fresnel texture 650.

FIG. 7 illustrates a first exemplary graph 702 that includes a bumped normal NB and a second exemplary graph 704 that includes a bumped view vector VB. Each of graphs 702 and 704 represents a Fresnel texture with a bumped surface. Each includes a normal N that points in the same direction as the positive Y-axis as well as a view vector V. As described further below, graph 702 includes the original un-bumped surface 706 and the bumped surface 708 because the normal N is bumped to produce the bumped normal N_{B}, but graph 704 includes only the un-bumped surface 706 because the view vector V is bumped to produce the bumped view vector V_{B} to thereby compute the Fresnel value with bump map without bumping the normal N.

Given a point P (x_{P}, yₚ, zₚ) on the ocean surface, the normalized view direction V (xᵥ, yᵥ, zᵥ) is computed for this point P. Because the normal N of the flat ocean surface points towards the positive Y-axis, “(xᵥ, zᵥ)” is used as the texture coordinates for the Fresnel texture map. To get the Fresnel value for this point, the view vector V is transformed in the local coordinate frame as defined for the Fresnel texture.

When the normal N on point P is bumped by (du, dv) as shown in graph 702 for plane 708 to produce the bumped normal N_{B}, the Fresnel term is changed accordingly. However, it is complicated to find the Fresnel value for the bumped normal N_{B}. To avoid or at least ameliorate this complication, instead of bumping the normal N for the Fresnel term computation, the view vector V is bumped directly by (−du, −dv) as shown in graph 704 to produce bumped view vector V_{B}. Consequently, the Fresnel term can be computed relatively easily by (xᵥ−du, zᵥ−dv).

Reflection on Bumped Ocean Surface

The reflection color caused by the environment can be computed from the reflection map or the environment map. In a described implementation, the reflection map is generated for each frame. In doing so, the ocean surface is regarded as a flat mirror and objects above the water are transformed to their mirror position with respect to the ocean surface. After rendering transformed objects into a texture, the object texture can be mapped to/on the ocean surface by projective texture mapping.

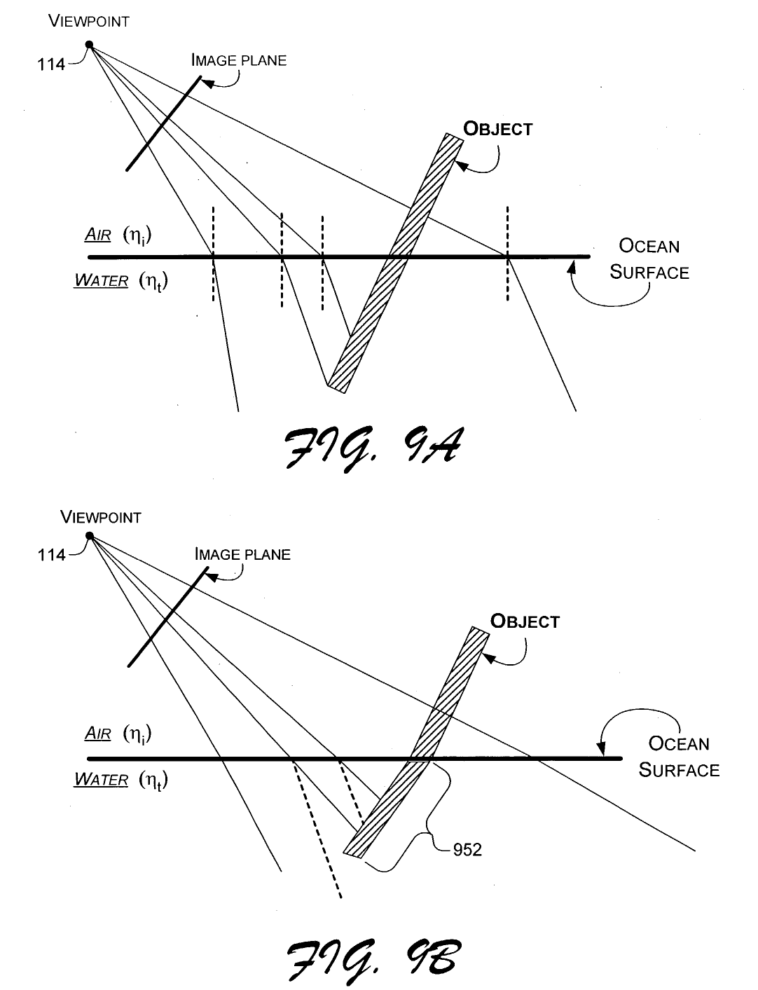

FIG. 8 is a graph that illustrates an exemplary bumped reflection map for a one dimensional (1D) case. The actual viewpoint 114 and the image plane are positioned above the surface of the ocean. These are transformed into a reflected viewpoint 114′ and a reflection map, respectively, below the ocean surface.

For a bumped ocean surface, tracing the bumped reflection direction to arrive at the correct result is difficult. To facilitate the computation, an alternative solution is to shift the original reflection map coordinates by the scaled bump map values (du, dv). As shown in FIG. 8, shifting the original reflection map coordinates by the scaled bump map values (du, dv) yields the correct result for less than all of the possible rays. Regardless, experimental investigation indicates that the rendering result is of an acceptable quality.

Refraction on Bumped Ocean Surface

Even for a flat ocean surface, the refraction direction for each view vector is usually computed for maximum accuracy, but such computation is complicated. One approach is to compute the refraction direction on each vertex and then to interpolate the refraction vector at each pixel. In a described implementation, however, the refraction effect is approximated by scaling the under-water scene along the Y-axis.

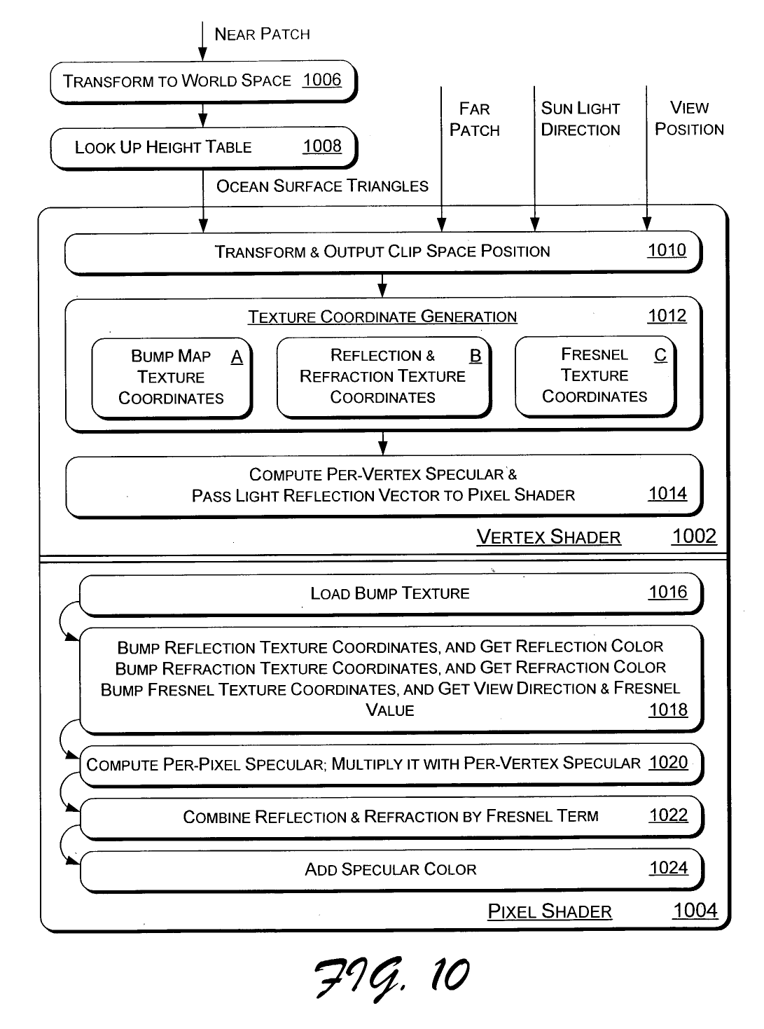

FIGS. 9A and 9B are graphs that illustrate an exemplary refraction map generation for a 1D case. Each graph includes a viewpoint 114, an image plane, the ocean surface, and an object. For each graph, four viewing rays are illustrated as emanating from viewpoint 114, propagating through the image plane, and piercing the ocean surface, where they are actually refracted by the change in transmission medium.

For FIG. 9A, these refracting rays are illustrated with the correct refraction direction. The point at which each refracting ray enters the ocean surface is marked by a vertical dashed line. At each vertical dashed line, the angle of the ray is changed due to the refraction.

For FIG. 9B, these refracting rays are not illustrated with the correct refraction direction. Instead, the underwater scene is scaled to approximate the refraction effects. For example, the illustrated object is shown as being shifted towards the ocean surface and viewpoint 114 to account for the refraction, as indicated by bracket 952.

Thus, the under-water scene is scaled and then rendered into the refraction map in each frame. In the refraction map, the refraction color is approximated with the following equation:

C_{refract}=α_{fog}(d)·C_{depth}_{_{—}}_{water}+(1−α_{fog}(d))·C_{obj}.

Here α_{fog}(d) is the exponential function of the water depth, which is used to simulate the water transmission effects that vary based on the depth or intervening volume of water.

The refraction map is also applied to the bumped ocean surface. As described above with regard to the reflection map, the textured coordinates of the refraction map are bumped directly to approximate the disturbed refraction rays.

Specular Computation

In a described implementation, the specular color resulting from directional sunlight is approximated by the Phong model, and the Fresnel effect for the specular is ignored. To compute the specular on each pixel, the normalized view vector V′ is stored in a channel (e.g., the RGB channel) of the Fresnel texture map.

Similar to a Fresnel computation, the normalized and bumped view vector is found in the Fresnel texture map. It is then used to compute (V_{B}·R_{SD})^{s} for each pixel, where R_{SD} is the reflected sunlight direction with respect to the default ocean surface normal (0.0, 1.0, 0.0) and the exponent “s” is specified before the rendering.

Single-Pass Rendering

FIG. 10 includes a vertex shader 1002 and a pixel shader 1004 that illustrate an exemplary approach for visualizing the surface of a liquid from a pipelined perspective. Vertex shader 1002 and pixel shader 1004 are typically part of and/or implemented by a GPU or other graphics subsystem of an electronic device. FIG. 10 includes ten (10) blocks 1006-1024, which may correspond to operations, units, mechanisms, etc. Although illustrated from a pipelined perspective, at least a portion of blocks 1006-1024 may alternatively be implemented fully or partially in parallel to speed execution.

Before rendering, displacement map 118 (from FIG. 1) and bump map 120 are generated by ocean wave simulation procedure 106. Also, patch construction procedure 108 produces near patch 112 and far patch 110. As shown in FIG. 10, near patch (112) is input to block 1006 to transform the abstract near patch into the current world space. At block 1008, the various heights for the transformed near patch are looked up in a height table using displacement map 118.

In rendering, the ocean surface triangles of the near patch, as transformed and raised by blocks 1006 and 1008, respectively, and the ocean surface triangles of the far patch (110) are input to vertex shader 1002. The sunlight direction and the current viewpoint (114) position are also input into the graphics pipeline.

Thus, the ocean surface triangles, the sunlight direction, and the current viewpoint are input to block 1010 of vertex shader 1002. At block 1010, the ocean surface is transformed and clipped according to the current viewpoint. The clipped ocean surface triangles are output to texture coordinate generation block 1012. At block 1012, the texture coordinates on each vertex for the bump map (block 1012A), for the reflection and refraction maps (block 1012B), and for the Fresnel map (block 1012C) are generated. At block 1014, the per-vertex specular is computed, and the light reflection vector is passed to pixel shader 1004.

In pixel shader 1004, the bump map texture is loaded, and the bump value for each pixel of the ocean surface triangles is found at block 1016. At block 1018, the texture coordinates for the reflection, refraction, and Fresnel maps are modified by bumping them in accordance with the bump map. Thus, the reflection color, the refraction color, and the Fresnel value for each pixel may be computed. The view direction is also found. The bump value for each texture coordinate is therefore used at block 1018 to bump the other different texture coordinates.

At block 1020, the per-pixel specular is computed, and this result is multiplied by the per-vertex specular that is computed at block 1014 of vertex shader 1002. The color components may then be composited together. Specifically, to arrive at a pixel color for the water that may be displayable on a screen, the computed reflection and refraction values are combined responsive to the computed Fresnel term at block 1022, and the specular color product from block 1020 is added at block 1024. Combining the computed reflection and refraction values by the corresponding Fresnel term enables at least a portion of the oceanic Fresnel effect to be represented on a per-pixel basis.

The approaches of FIGS. 1 and 10, for example, are illustrated in diagrams that are divided into multiple blocks. However, the order and/or layout in which the approaches are described and/or shown is not intended to be construed as a limitation, and any number of the blocks can be combined and/or re-arranged in any order to implement one or more systems, methods, media, arrangements, etc. for visualizing the surface of a liquid. Furthermore, although the description herein includes references to specific implementations such as that of FIG. 10 (as well as the exemplary system environment of FIG. 11), the approaches can be implemented in any suitable hardware, software, firmware, or combination thereof and using any suitable programming language, coding mechanisms, graphics paradigms, and so forth.

Exemplary Operating Environment for Computer or Other Electronic Device

FIG. 11 illustrates an exemplary computing (or general electronic device) operating environment 1100 that is capable of (fully or partially) implementing at least one system, device, component, approach, method, process, some combination thereof, etc. for visualizing the surface of a liquid as described herein. Computing environment 1100 may be utilized in the computer and network architectures described below or in a stand-alone situation.

Exemplary electronic device operating environment 1100 is only one example of an environment and is not intended to suggest any limitation as to the scope of use or functionality of the applicable electronic (including computer, game console, portable game, simulation, etc.) architectures. Neither should electronic device environment 1100 be interpreted as having any dependency or requirement relating to any one or any combination of components as illustrated in FIG. 11.

Additionally, visualizing the surface of a liquid may be implemented with numerous other general purpose or special purpose electronic device (including computing system) environments or configurations. Examples of well known electronic (device) systems, environments, and/or configurations that may be suitable for use include, but are not limited to, personal computers, server computers, thin clients, thick clients, personal digital assistants (PDAs) or mobile telephones, hand-held or laptop devices, multiprocessor systems, microprocessor-based systems, set top boxes, programmable consumer electronics, video game machines, game consoles, portable or handheld gaming units, network PCs, minicomputers, mainframe computers, distributed computing environments that include any of the above systems or devices, some combination thereof, and so forth.

Implementations for visualizing the surface of a liquid may be described in the general context of electronically-executable instructions. Generally, electronically-executable instructions include routines, programs, objects, components, data structures, etc. that perform particular tasks or implement particular abstract data types. Facilitating the visualization of the surface of a liquid, as described in certain implementations herein, may also be practiced in distributed computing environments where tasks are performed by remotely-linked processing devices that are connected through a communications link and/or network. Especially in a distributed computing environment, electronically-executable instructions may be located in separate storage media, executed by different processors, and/or propagated over transmission media.

Electronic device environment 1100 includes a general-purpose computing device in the form of a computer 1102, which may comprise any electronic device with computing and/or processing capabilities. The components of computer 1102 may include, but are not limited to, one or more processors or processing units 1104, a system memory 1106, and a system bus 1108 that couples various system components including processor 1104 to system memory 1106.

System bus 1108 represents one or more of any of several types of wired or wireless bus structures, including a memory bus or memory controller, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, some combination thereof, and so forth.

Computer 1102 typically includes a variety of electronically-accessible media. Such media may be any available media that is accessible by computer 1102 or another electronic device, and it includes both volatile and non-volatile media, removable and non-removable media, and storage and transmission media.

System memory 1106 includes electronically-accessible storage media in the form of volatile memory, such as random access memory (RAM) 1110, and/or non-volatile memory, such as read only memory (ROM) 1112. A basic input/output system (BIOS) 1114, containing the basic routines that help to transfer information between elements within computer 1102, such as during start-up, is typically stored in ROM 1112. RAM 1110 typically contains data and/or program modules/instructions that are immediately accessible to and/or being presently operated on by processing unit 1104.

Computer 1102 may also include other removable/non-removable and/or volatile/non-volatile storage media. By way of example, FIG. 11 illustrates a hard disk drive or disk drive array 1116 for reading from and writing to a (typically) non-removable, non-volatile magnetic media (not separately shown); a magnetic disk drive 1118 for reading from and writing to a (typically) removable, non-volatile magnetic disk 1120 (e.g., a “floppy disk”); and an optical disk drive 1122 for reading from and/or writing to a (typically) removable, non-volatile optical disk 1124 such as a CD-ROM, DVD-ROM, or other optical media. Hard disk drive 1116, magnetic disk drive 1118, and optical disk drive 1122 are each connected to system bus 1108 by one or more storage media interfaces 1126. Alternatively, hard disk drive 1116, magnetic disk drive 1118, and optical disk drive 1122 may be connected to system bus 1108 by one or more other separate or combined interfaces (not shown).

The disk drives and their associated electronically-accessible media provide non-volatile storage of electronically-executable instructions, such as data structures, program modules, and other data for computer 1102. Although exemplary computer 1102 illustrates a hard disk 1116, a removable magnetic disk 1120, and a removable optical disk 1124, it is to be appreciated that other types of electronically-accessible media may store instructions that are accessible by an electronic device, such as magnetic cassettes or other magnetic storage devices, flash memory, CD-ROM, digital versatile disks (DVD) or other optical storage, RAM, ROM, electrically-erasable programmable read-only memories (EEPROM), and so forth. Such media may also include so-called special purpose or hard-wired integrated circuit (IC) chips. In other words, any electronically-accessible media may be utilized to realize the storage media of the exemplary electronic system and environment 1100.

Any number of program modules (or other units or sets of instructions) may be stored on hard disk 1116, magnetic disk 1120, optical disk 1124, ROM 1112, and/or RAM 1110, including by way of general example, an operating system 1128, one or more application programs 1130, other program modules 1132, and program data 1134. By way of specific example but not limitation, coding for programming a vertex shader 1002 and a pixel shader 1004 (of FIG. 10) may be located in any one or more of operating system 1128, application programs 1130, and other program modules 1132. Also, a viewpoint 114 (from FIG. 1 et seq.) and other environmental and/or world information may be located at program data 1134.

A user that is playing a game or experiencing a simulation, for example, may enter commands and/or information into computer 1102 via input devices such as a keyboard 1136 and a pointing device 1138 (e.g., a “mouse”). Other input devices 1140 (not shown specifically) may include a microphone, joystick, game pad, satellite dish, serial port, scanner, and/or the like. These and other input devices are connected to processing unit 1104 via input/output interfaces 1142 that are coupled to system bus 1108. However, they may instead be connected by other interface and bus structures, such as a parallel port, a game port, a universal serial bus (USB) port, an IEEE 1394 (“Firewire”) interface, an IEEE 802.11 wireless interface, a Bluetooth® wireless interface, and so forth.

A monitor/view screen 1144 or other type of display device may also be connected to system bus 1108 via an interface, such as a video adapter 1146. Video adapter 1146 (or another component) may be or may include a graphics card for processing graphics-intensive calculations and for handling demanding display requirements. Typically, a graphics card includes a GPU, video RAM (VRAM), etc. to facilitated the expeditious performance of graphics operations. In addition to monitor 1144, other output peripheral devices may include components such as speakers (not shown) and a printer 1148, which may be connected to computer 1102 via input/output interfaces 1142.

Computer 1102 may operate in a networked environment using logical connections to one or more remote computers, such as a remote computing device 1150. By way of example, remote computing device 1150 may be a personal computer, a portable computer (e.g., laptop computer, tablet computer, PDA, mobile station, etc.), a palm or pocket-sized computer, a gaming device, a server, a router, a network computer, a peer device, other common network node, or another computer type as listed above, and so forth. However, remote computing device 1150 is illustrated as a portable computer that may include many or all of the elements and features described herein with respect to computer 1102.

Logical connections between computer 1102 and remote computer 1150 are depicted as a local area network (LAN) 1152 and a general wide area network (WAN) 1154. Such networking environments are commonplace in offices, enterprise-wide computer networks, intranets, the Internet, fixed and mobile telephone networks, other wireless networks, gaming networks, some combination thereof, and so forth.

When implemented in a LAN networking environment, computer 1102 is usually connected to LAN 1152 via a network interface or adapter 1156. When implemented in a WAN networking environment, computer 1102 typically includes a modem 1158 or other means for establishing communications over WAN 1154. Modem 1158, which may be internal or external to computer 1102, may be connected to system bus 1108 via input/output interfaces 1142 or any other appropriate scheme(s). It is to be appreciated that the illustrated network connections are exemplary and that other means of establishing communication link(s) between computers 1102 and 1150 may be employed.

In a networked environment, such as that illustrated with electronic device environment 1100, program modules or other instructions that are depicted relative to computer 1102, or portions thereof, may be fully or partially stored in a remote memory storage device. By way of example, remote application programs 1160 reside on a memory component of remote computer 1150 but may be usable or otherwise accessible via computer 1102. Also, for purposes of illustration, application programs 1130 and other electronically-executable instructions such as operating system 1128 are illustrated herein as discrete blocks, but it is recognized that such programs, components, and other instructions reside at various times in different storage components of computing device 1102 (and/or remote computing device 1150) and are executed by data processor(s) 1104 of computer 1102 (and/or those of remote computing device 1150).

Although systems, media, methods, approaches, processes, arrangement, and other implementations have been described in language specific to structural, algorithmic, and functional features and/or diagrams, it is to be understood that the invention defined in the appended claims is not necessarily limited to the specific features or diagrams described. Rather, the specific features and diagrams are disclosed as exemplary forms of implementing the claimed invention.

1. One or more electronically-accessible media comprising electronically-executable instructions that, when executed, direct an electronic device to execute operations comprising:
simulate a near patch of a surface of a liquid that is proximate to a viewpoint, the near patch including a representation of liquid waves in three dimensions; and
simulate a far patch of the surface of the liquid that is distant from the viewpoint.

2. The one or more electronically-accessible media as recited in claim 1, wherein the liquid comprises an ocean and the electronically-executable instructions, when executed, direct the electronic device to execute a further operation comprising:
render the surface of the ocean using at least a portion of each of the near patch and the far patch to produce a resulting image using a Fresnel texture map.

3. The one or more electronically-accessible media as recited in claim 1, comprising the electronically-executable instructions that, when executed, direct the electronic device to execute a further operation comprising:
blend the near patch with the far patch by culling triangles of the far patch that are located completely within a region corresponding to the near patch.

4. The one or more electronically-accessible media as recited in claim 1, comprising the electronically-executable instructions that, when executed, direct the electronic device to execute a further operation comprising:
blend the near patch with the far patch by setting to zero height values for vertices of triangles of the near patch that are located on a border between the near patch and the far patch.

5. The one or more electronically-accessible media as recited in claim 1, comprising the electronically-executable instructions that, when executed, direct the electronic device to execute a further operation comprising:
blend the near patch with the far patch by:
identifying overlapping triangles of the far patch that are partially within the near patch; and
moving vertices of the overlapping triangles of the far patch that are located within the near patch to a border between the near patch and the far patch.

6. The one or more electronically-accessible media as recited in claim 1, wherein the far patch is planar.

7. The one or more electronically-accessible media as recited in claim 1, wherein vertices of triangles that form the far patch have height values of zero.

8. The one or more electronically-accessible media as recited in claim 1, wherein at least a portion of the electronically-executable instructions comprise at least part of a game program.

9. The one or more electronically-accessible media as recited in claim 1, wherein the media is accessible to at least one game console.

10. The one or more electronically-accessible media as recited in claim 1, wherein the media is accessible to at least one personal computer.

11. The one or more electronically-accessible media as recited in claim 1, wherein the operation to simulate the near patch of the surface of the liquid comprises an operation to create the near patch such that the near patch is at least approximately centered on the viewpoint.

12. The one or more electronically-accessible media as recited in claim 1, wherein the operation to simulate the near patch of the surface of the liquid comprises an operation to create the near patch such that the near patch is at least approximately rectangular.

13. The one or more electronically-accessible media as recited in claim 1, wherein the operation to simulate the near patch of the surface of the liquid comprises an operation to create the near patch such that a size of the near patch is set sufficiently large so as to cover substantially all waves of the liquid that have visible height variations for substantially all viewing heights at and for substantially all viewing directions from the viewpoint.

14. The one or more electronically-accessible media as recited in claim 1, wherein the operation to simulate the far patch of the surface of the liquid comprises an operation to create the far patch such that the far patch extends approximately from a distal edge of the near patch to a horizon of the current world space.

15. The one or more electronically-accessible media as recited in claim 1, wherein the operation to simulate the far patch of the surface of the liquid comprises an operation to create the far patch such that the far patch is located at a distal edge of the near patch along a current viewing direction.

16. The one or more electronically-accessible media as recited in claim 1, wherein the operation to simulate the far patch of the surface of the liquid comprises an operation to create the far patch such that the far patch is at least as wide as a viewing frustum that defines a visible region extending from the viewpoint in a triangular or wedge shape across the near patch and over the far patch to a horizon of the current world space along a current viewing direction.

17. The one or more electronically-accessible media as recited in claim 1, wherein the operation to simulate the far patch of the surface of the liquid comprises an operation to create the far patch without applying a height value thereto but using a bump map therefor.

18. One or more electronically-accessible media comprising electronically-executable instructions that, when executed, direct an electronic device to perform actions comprising:
establishing a liquid surface simulation that includes a near patch and a far patch, the near patch and the far patch positioned with respect to a viewpoint; and
modifying the near patch and the far patch independently responsive to movements of or associated with the viewpoint.

19. The one or more electronically-accessible media as recited in claim 18, wherein the action of modifying further comprises:
when an altitude of the viewpoint decreases,
decreasing a resolution of the near patch, and
decreasing a length of the far patch.

20. The one or more electronically-accessible media as recited in claim 18, wherein the action of modifying further comprises:
when an altitude of the viewpoint increases,
increasing a resolution of the near patch, and
increasing a length of the far patch by scaling the far patch to cover a newly visible area of the liquid surface.

21. The one or more electronically-accessible media as recited in claim 18, wherein the action of modifying further comprises:
when the viewpoint moves left or right and/or backwards or forwards,
moving a mesh of the near patch left or right and/or backwards or forwards, respectively.

22. The one or more electronically-accessible media as recited in claim 18, wherein the action of modifying further comprises:
when a viewing direction that is associated with the viewpoint rotates around an axis that is parallel to a normal to the liquid surface and that is located at the viewpoint,
rotating the far patch in an arc with respect to the viewpoint.

23. One or more electronically-accessible media comprising electronically-executable instructions that, when executed, direct an electronic device to perform actions comprising:
creating a displacement map that represent large-scale wave features of a liquid;
creating a bump map that represents small-scale wave features of the liquid;
constructing a near patch that represents a surface of the liquid with a three-dimensional field using the displacement map; and
constructing a far patch that represents the surface of the liquid with a planar field using the bump map.

24. The one or more electronically-accessible media as recited in claim 23, wherein the actions of creating a displacement map and creating a bump map comprise, respectively, creating the displacement map and creating the bump map using an equation that is based on experimental observations of the liquid and a statistical model thereof.

25. The one or more electronically-accessible media as recited in claim 23, wherein the actions of creating a displacement map and creating a bump map comprise, respectively, creating the displacement map by sampling an equation at a first spatial resolution and creating the bump map by sampling the equation at a second spatial resolution, the first spatial resolution being lower than the second spatial resolution.

26. The one or more electronically-accessible media as recited in claim 25, wherein the first spatial resolution is approximately an order of magnitude lower than the second spatial resolution.

27. The one or more electronically-accessible media as recited in claim 23, comprising the electronically-executable instructions that, when executed, direct the electronic device to perform a further action comprising:
tessellating the far patch based on a current viewing distance.

28. The one or more electronically-accessible media as recited in claim 23, wherein the action of constructing a near patch comprises:
constructing the near patch such that the near patch is at least approximately centered on and extending around a current viewpoint.

29. The one or more electronically-accessible media as recited in claim 23, wherein the action of constructing a near patch comprises:
constructing the near patch such that a size of the near patch is set sufficiently large so as to cover substantially all waves of the liquid that have visible height variations for substantially all viewing heights at and for substantially all viewing directions from a given viewpoint.

30. The one or more electronically-accessible media as recited in claim 23, wherein the action of constructing a far patch comprises:
constructing the far patch such that the far patch extends approximately from a distal edge of the near patch, with respect to a given viewpoint, to a horizon of the current world space.

31. The one or more electronically-accessible media as recited in claim 23, wherein the action of constructing a near patch comprises:
constructing the near patch using the bump map.

32. The one or more electronically-accessible media as recited in claim 23, comprising the electronically-executable instructions that, when executed, direct the electronic device to perform a further action comprising:
stitching together the near patch and the far patch to produce a joint representation of the surface of the liquid.

33. The one or more electronically-accessible media as recited in claim 32, wherein the action of stitching together the near patch and the far patch comprises:
setting to zero height values for vertices of triangles of the near patch that are located on a border between the near patch and the far patch;
culling triangles of the far patch that are located completely within the near patch; and
identifying overlapping triangles of the far patch that are partially within the near patch and moving vertices of the overlapping triangles of the far patch that are located within the near patch to the border between the near patch and the far patch.

34. The one or more electronically-accessible media as recited in claim 23, comprising the electronically-executable instructions that, when executed, direct the electronic device to perform further actions comprising:
creating a Fresnel texture map; and
bumping the Fresnel texture map to produce a bumped Fresnel value using the bump map.

35. The one or more electronically-accessible media as recited in claim 34, comprising the electronically-executable instructions that, when executed, direct the electronic device to perform further actions comprising:
rendering the near patch using the bumped Fresnel value; and
rendering the far patch using the bumped Fresnel value.

36. The one or more electronically-accessible media as recited in claim 35, wherein the actions of rendering the near patch and rendering the far patch comprise, respectively:
rendering the near patch using a bumped refraction map and a bumped reflection map; and
rendering the far patch using the bumped refraction map and the bumped reflection map.

37. An electronic device that is adapted to visualize a surface of a liquid that has waves, the electronic device configured to simulate and render the surface of the liquid using (i) a view-dependent representation of wave geometry, wherein waves that are relatively closer to a current viewpoint are rendered with greater accuracy than waves that are relatively farther from the current viewpoint; and (ii) a Fresnel bump mapping for representing Fresnel reflection and refraction effects, wherein the Fresnel bump mapping enables rendering of per-pixel Fresnel reflection and refraction in accordance with a dynamic bump map.

38. The electronic device as recited in claim 37, wherein the electronic device comprises at least one of a game console, a portable game player, and a personal computer.

39. The electronic device as recited in claim 37, wherein the surface of the liquid comprises the surface of an ocean that is being visualized for a game.

40. One or more electronically-accessible media comprising electronically-executable instructions that, when executed, direct an electronic device to perform actions comprising:
simulating a surface of a liquid to determine dimensional wave features; and
rendering the surface of the liquid by applying a Fresnel texture map to the dimensional wave features.

41. The one or more electronically-accessible media as recited in claim 40, wherein the action of simulating comprises:
creating a displacement map that represents the dimensional wave features of the surface of the liquid on a large-scale; and
creating a bump map that represents the dimensional wave features of the surface of the liquid on a small-scale.

42. The one or more electronically-accessible media as recited in claim 40, wherein the action of rendering comprises:
rendering the surface of the liquid by applying the Fresnel texture map to the dimensional wave features on a per-pixel basis.

43. The one or more electronically-accessible media as recited in claim 40, wherein the action of rendering comprises:
rendering the surface of the liquid by applying the Fresnel texture map to the dimensional wave features, wherein the Fresnel texture map comprises a plurality of pre-computed Fresnel terms.

44. The one or more electronically-accessible media as recited in claim 40, wherein the action of rendering comprises:
rendering the surface of the liquid by applying a reflection map; and
rendering the surface of the liquid by applying a refraction map.

45. The one or more electronically-accessible media as recited in claim 44, wherein the action of rendering the surface of the liquid by applying a reflection map comprises:
computing the reflection map by transforming at least one object that is above the surface of the liquid to a mirror position for the at least one object below the surface of the liquid with respect to the surface of the liquid.

46. The one or more electronically-accessible media as recited in claim 44, wherein the action of rendering the surface of the liquid by applying a refraction map comprises:
computing the refraction map by scaling a scene that is under the surface of the liquid toward the surface of the liquid along an axis that is parallel to a normal to the surface of the liquid.

47. The one or more electronically-accessible media as recited in claim 40, wherein the action of rendering comprises:
rendering the surface of the liquid by applying a bumped reflection map.

48. The one or more electronically-accessible media as recited in claim 47, wherein the action of rendering further comprises:
computing the bumped reflection map by shifting reflection map coordinates by scaled bump values.

49. The one or more electronically-accessible media as recited in claim 40, wherein the action of rendering comprises:
rendering the surface of the liquid by applying a bumped refraction map.

50. The one or more electronically-accessible media as recited in claim 49, wherein the action of rendering further comprises:
computing the bumped refraction map by shifting reflection map coordinates by scaled bump values.

51. The one or more electronically-accessible media as recited in claim 40, comprising the electronically-executable instructions that, when executed, direct the electronic device to perform a further action comprising:
creating the Fresnel texture map by computing a Fresnel term for a plurality of viewing directions for each texel, the Fresnel texture map comprising a two-dimensional (2D) texture map.

52. The one or more electronically-accessible media as recited in claim 40, wherein the Fresnel texture map comprises a bumped Fresnel texture mapping, is and wherein the electronically-executable instructions, when executed, direct the electronic device to perform a further action comprising:
creating the bumped Fresnel texture mapping by computing Fresnel terms for a plurality of viewing directions using a plurality of bumped view vectors.

53. The one or more electronically-accessible media as recited in claim 40, comprising the electronically-executable instructions that, when executed, direct the electronic device to perform a further action comprising:
constructing a far patch and a near patch of the surface of the liquid, the far patch and the near patch dependent upon at least one of a viewpoint and a view direction.

54. The one or more electronically-accessible media as recited in claim 53, wherein the action of rendering comprises:
rendering the surface of the liquid using the far patch and the near patch.

55. A system for rendering a surface of a liquid, the system comprising: at least one pixel shader, the at least one pixel shader including:
a loading mechanism that is adapted to load a bump texture that represents a small-scale simulation of the surface of the liquid and to load at least a portion of a Fresnel map;
a bumping mechanism that is capable of bumping texture coordinates using the bump texture, the bumping mechanism adapted to: bump reflection texture coordinates and compute a reflection color component, bump refraction texture coordinates and compute a refraction color component, and bump Fresnel texture coordinates from the at least a portion of the Fresnel map and ascertain a Fresnel value; and
a combining mechanism that is adapted to combine the reflection color component and the refraction color component responsive to the Fresnel value.

56. The system as recited in claim 55, wherein the at least one pixel shader further includes:
a specular computing mechanism that is adapted to compute a specular value on a per-pixel basis, the specular computing mechanism further adapted to compute a specular color component by multiplying the specular value by a per-vertex specular level.

57. The system as recited in claim 56, wherein the combining mechanism is further adapted to determine a color of the surface of the liquid using (i) the reflection color component and the refraction color component in conjunction with the Fresnel value and (ii) the specular color component.

58. The system as recited in claim 55, wherein the Fresnel map is pre-computed.

59. The system as recited in claim 55, wherein the Fresnel map is two dimensional (2D).

60. The system as recited in claim 55, wherein the reflection texture coordinates are from at least a portion of a reflection map.

61. The system as recited in claim 55, wherein the refraction texture coordinates are from at least a portion of a refraction map.

62. The system as recited in claim 55, wherein the system comprises at least one electronic device.

63. The system as recited in claim 62, wherein the at least one electronic device comprises a gaming console and/or a personal computer.

64. The system as recited in claim 62, wherein the at least one electronic device comprises a graphics processing unit (GPU) and/or a graphics card.

65. The system as recited in claim 55, wherein the system further comprises:
at least one vertex shader, the at least one vertex shader including:
a transforming and clipping mechanism that is adapted to receive a plurality of liquid surface triangles representing the surface of the liquid and a current viewpoint position and to output a plurality of transformed and clipped triangles responsive to the current viewpoint position.

66. The system as recited in claim 65, wherein the plurality of liquid surface triangles include a first portion of triangles that correspond to a near patch of the surface of the liquid and a second portion of triangles that correspond to a far patch of the surface of the liquid.

67. The system as recited in claim 66, wherein the first portion of triangles that correspond to the near patch represents differing three-dimensional heights of the surface of the liquid.

68. The system as recited in claim 65, wherein the at least one vertex shader further includes:
a texture coordinate generating mechanism that is capable of generating texture coordinates, the texture coordinate generating mechanism adapted to: generate texture coordinates at each vertex of each triangle of the plurality of transformed and clipped triangles for a bump map having the bump texture, for a reflection map having the reflection texture coordinates, for a refraction map having the refraction texture coordinates, and for the Fresnel map having the Fresnel texture coordinates.

69. One or more electronically-accessible media comprising liquid visualizing electronically-executable instructions that, when executed, direct an electronic device to perform actions comprising:
simulating a liquid by creating a displacement map that represent large-scale wave features of the liquid and by creating a bump map that represents small-scale wave features of the liquid;
constructing a near patch and a far patch; the near patch representing a surface of the liquid with a three-dimensional field using the displacement map, and the far patch representing the surface of the liquid with a planar field using the bump map; the near patch located proximal to a viewpoint, and the far patch located distal from the viewpoint;
generating a Fresnel texture map, a reflection texture map, and a refraction texture map;
perturbing each of the Fresnel texture map, the reflection texture map, and the refraction texture map using the bump map to produce perturbed Fresnel values, perturbed reflection values, and perturbed refraction values, respectively; and
determining colors of the surface of the liquid using the perturbed reflection values and the perturbed refraction values in conjunction with the perturbed Fresnel values.

70. The one or more electronically-accessible media as recited in claim 69, comprising the liquid visualizing electronically-executable instructions that, when executed, direct the electronic device to perform a further action comprising:
computing specular values responsive to a current sunlight direction; and
wherein the action of determining colors comprises:
determining the colors of the surface of the liquid using the specular values.

71. An arrangement for simulating a liquid, the arrangement comprising:
simulation means for creating a displacement map that represent large-scale wave features of the liquid and for creating a bump map that represents small-scale wave features of the liquid; and
construction means for establishing a near patch and a far patch responsive to a current viewpoint; the construction means establishing the near patch to represent a surface of the liquid with a three-dimensional field using the displacement map and establishing the far patch to represent the surface of the liquid with a planar field using the bump map.

72. The arrangement as recited in claim 71, wherein the arrangement comprises at least one of an electronically-accessible media and an electronic device.

73. An arrangement for rendering a liquid, the arrangement comprising:
Fresnel effect means for mapping a Fresnel texture for a plurality of different viewing vectors;
reflection means for creating a reflection texture map;
refraction means for creating a refraction texture map;
bumping means for bumping the Fresnel texture, the reflection texture map, and the refraction texture map to produce bumped Fresnel texture coordinates, bumped reflection texture coordinates, and bumped refraction texture coordinates, respectively; and
combining means for combining the bumped reflection texture coordinates and the bumped refraction texture coordinates in accordance with the bumped Fresnel texture coordinates.

74. The arrangement as recited in claim 73, wherein the arrangement comprises at least one of an electronically-accessible media and an electronic device.

75. The arrangement as recited in claim 73, wherein the Fresnel effect means, the reflection means, the refraction means, the bumping means, and the combining means are capable of operating on a per-pixel basis.

76. The arrangement as recited in claim 73, further comprising:
computing means for computing specular color values; and
color determining means for determining colors of a surface of the liquid using the specular color values and at least one result from the combining means.
